(19) United States
(12) Patent Application Publication
(10) Pub. No.: US 2006/0007603 A1
(43) Pub. Date: Jan. 12, 2006

(54) Magnetoresistive sensor with refill film, fabrication process, and magnetic disk storage apparatus mounting magnetoresistive sensor

(75) Inventors: Kenichi Meguro, Kanagawa (JP); Taku Shintani, Kanagawa (JP); Katsuro Watanabe, Ibaraki (JP); Nobuo Yoshida, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/177,967

(22) Filed: Jul. 8, 2005

(30) Foreign Application Priority Data
Jul. 8, 2004 (JP) 2004-202343

(51) Int. Cl. G11B 5/33; G11B 5/127; G11B 5/147

(52) U.S. Cl. 360/320

(57) ABSTRACT

Embodiments of the invention provide a high-output magnetic reading head by making it easy to remove a re-deposited substance that deposits on the side wall surface in the track width direction or the side wall surface in the sensor height direction of a magneto-resistance film in a fabrication process of the magnetic reading head. In one embodiment, a refill film that is fabricated first of a refill film along track width direction or a refill film along sensor height direction is fabricated such that a layer in contact with the magneto-resistance film is formed of a material that is slow in etching rate but possible to minimize deterioration of characteristics due to thermal treatment and a layer(s) other than the layer in contact with the magneto-resistance film is formed of a material(s) that is fast in etching rate.

### CROSS-REFERENCES TO RELATED APPLICATIONS

This application claims priority from Japanese Patent Application No. JP2004-202343, filed Jul. 8, 2004, the entire disclosure of which is incorporated herein by reference.

### BACKGROUND OF THE INVENTION

The present invention relates to a magnetic head that allows reading magnetically recorded information, its fabrication process, and a magnetic recording apparatus mounting the magnetic head, and particularly relates to the magnetic head that has a high output and the magnetic recording apparatus mounting this.

A magneto-resistive sensor making use of magnetic resistance effect in which electric resistance changes in response to changes in external magnetic field is known to be an excellent magnetic sensor, and is in practical use as a reading element to detect signal magnetic field from a magnetic recording medium in a magnetic head that is a main component of a magnetic recording apparatus.

The recording density of a magnetic recording apparatus continues to increase strikingly, and not only narrowing of track width of a magnetic head but also its high performance with respect to characteristics in both write and read is demanded. Concerning the read performance, enhancement in sensitivity is proceeding by developing a magneto-resistance head (MR head) that utilizes the magnetic resistance effect. Although magnetic signals on a recording medium were converted to electronic signals using anisotropy magneto-resistance (AMR) at a low recording density like several Gb/inch², giant magneto-resistance (GMR) with higher sensitivity is employed for a higher recording density exceeding this level.

For a demand of further higher recording density, research and development are being carried out on a system allowing sensing current to flow in the direction approximately perpendicular to a film plane (CPP mode), which has an advantage in achievement of high sensitivity as the distance between an upper shield layer and a lower shield layer (shield-to-shield distance) is narrowed, and magnetic reading heads that make use of CPP-GMR and tunneling magneto-resistance (TMR) have been reported.

The basic structure of a magnetic reading head in CPP mode is explained using FIGS. 1 and 2. FIG. 1 shows a cross section parallel to an air bearing surface (cross section perpendicular to the direction along sensor height) of the magnetic reading head in CPP mode. The x-axis, y-axis, and z-axis in FIG. 1 indicate the direction along track width, direction along sensor height, and direction along film thickness of the magneto-resistance film, respectively. The x-axes, y-axes, and z-axes in the following figures indicate the same axes as the x-axis, y-axis, and z-axis in FIG. 1, respectively. A refill film along track width direction 1 is provided in contact with the side wall of a magneto-resistance film 3 in the track width direction. A longitudinal bias layer or a side shield layer 5 may or may not be provided. It should be noted that 2 represents an upper shield layer and 4 represents a lower shield layer in FIG. 1. FIG. 2 is a cross section in the sensor height direction of the magnetic reading head in CPP mode when cut along the line aa′ in FIG. 1. The right side in FIG. 2 is the air bearing surface 13 of the magnetic reading head. A refill film along sensor height direction 6 is provided in contact with the wall of the magneto-resistance film 3 as in the case of the direction along track width. For the refill film along track width direction 1 and the refill film along sensor height direction 6, alumina serving as an insulating film is predominantly used.

The magnetic reading head in CPP mode is generally fabricated such that the upper and lower shield layers 2 and 4 contact electrically with the magneto-resistance film 3 respectively in order to minimize shield-to-shield distance. The upper shield layer 2 and the lower shield layer 4 also serve as electrodes to pass an electric current through the magneto-resistance film 3. In this case, when there exists a circuit to cause an electric short between the upper and lower shield layers 2 and 4 other than the magneto-resistance film 3, this circuit becomes a leak pass of sensing current, resulting in a decrease of the output.

The side wall surface of the magneto-resistance film 3 itself is listed as one of the possible places of occurrence of short circuit. This is related to the fabrication process of the magnetic reading head. FIG. 3 shows two kinds of flow charts for processing the magnetic reading head in CPP mode. The fabrication process of the magnetic reading head includes a fabrication step of the lower shield layer, a step of the magneto-resistance film fabrication, a patterning step of the magneto-resistance film, and a fabrication step of the upper shield layer. The difference between the two process flows shown in FIGS. 3(a) and 3(b) is only the order of steps of a sensor height fabrication and a track fabrication of the magneto-resistance film. This order varies according to the circumstances and either step may be carried out first.

As shown in FIG. 4, the magneto-resistance film 3 is protected by a predetermined size of a resist mask 8 or 11, or the like during the step of the sensor height fabrication and the step of the track fabrication by patterning of the magneto-resistance film (FIG. 4(b)), and unnecessary area is etched (FIG. 4(c)). Generally, ion beam etching by Ar ion and reactive ion etching (RIE) by chlorinated gas or carbonyl compound gas are used for this etching step. After the etching, the refill film along sensor height direction 6 or the refill film along track width direction 1 is fabricated (FIG. 4(d)), and then the resist mask 8 or 11 and excess refill film are removed by a lift-off method (FIG. 4(e)). Thus, the sensor height and the track width of the magneto-resistance film are fabricated, respectively.

It should be noted that there may be cases where a longitudinal bias layer or a side shield film is further fabricated over the refill film along track width direction 1 in the step of the track fabrication, although not shown in FIG. 4. At the time of this etching (FIG. 4(c)), a phenomenon called re-deposition that etching substance deposits again on the wall surface of the magneto-resistance film 3 occurs. This re-deposited substance is a stack film composed of a metal forming the magneto-resistance film 3 or the lower shield layer 4 and is electrically conductive, and therefore there is the possibility of becoming a leak pass of the sensing current described above.

As a means to prevent the sensing current from leaking due to this deposited substance, a method for preventing the leak of the sensing current, caused by the re-deposit attaching to the wall surface of the magneto-resistance film 3 in the track width direction, by oxidizing the re-deposited substance after etching at the time of performing the step of the track fabrication is disclosed in JP-A No. 86861/2003. This method is characterized in that the re-deposited substance is exploited as part of the refill film along track width direction by oxidizing it.

Further, a method for removing the re-deposited substance attaching to the wall surface of the magneto-resistance film 3 is disclosed in JP-A No. 26423/2002, in which, as shown in FIG. 5, the magneto-resistance film 3 fabricated on the lower shield layer 4 is masked in a predetermined shape with the resist mask 8 for the track fabrication or the resist mask 11 for the sensor height fabrication in the etching shown in FIG. 4(c), and the etching is carried out by allowing an ion beam to enter at a first incident angle θ₁, followed by another etching with an ion beam entering at a second incident angle θ₂ which is more oblique than the incident angle for the first etching (θ₂>θ₁) with respect to the magneto-resistance film 3. It should be noted that incident angle here is defined as the angle of an incident ion with respect to the normal to a substrate.

### BRIEF SUMMARY OF THE INVENTION

An area shadowed by the refill film where the ion beam is not fully irradiated exists even by the two-step etching as described above. Accordingly, there is a possibility that the re-deposited layer is not sufficiently removed and that leak of sensing current occurs. The area shadowed by the refill film differs depending on the order of the track fabrication step and the sensor height fabrication step for the magneto-resistance film 3.

To begin with, a case where the sensor height fabrication step is carried out before the track fabrication step (FIG. 3(a)) is explained. In this case, an area shadowed by the refill film along sensor height direction 6 is generated in etching for the track fabrication. FIG. 6 is a schematic diagram in which appearances of the vicinity of the back portion in the sensor height direction before the first etching (FIG. 6(a)) and after the first etching in the case where the sensor height fabrication step is carried out before the track fabrication step are viewed from the air bearing surface side. In FIG. 6, the front side (+Y direction) corresponds to the direction serving as the air bearing surface of the magnetic reading head. After the sensor height fabrication, the magneto-resistance film 3 and the refill film along sensor height direction 6 are masked by a lift-off mask 8 (FIG. 6(a)), and areas other than the masked area are removed by the first etching (FIG. 6(b)). An interface 7 indicates the interface between the magneto-resistance film 3 and the refill film along sensor height direction 6, and this interface is formed by etching in the sensor height fabrication step.

In the first etching, there is a difference in the etching rates between the magneto-resistance film 3 and the refill film along sensor height direction 6, and therefore, a difference in level A occurs on both sides of the magneto-resistance film 3 with respect to the refill film along sensor height direction 6 as shown in FIG. 6(b). Owing to the difference in level A caused by the refill film along sensor height direction 6, an area 10 shadowed in the second etching to be performed hereafter is generated in the area surrounded by the magneto-resistance film 3, the resist mask 8, and the refill film along sensor height direction 6. The second etching is carried out at an incident angle more oblique than the incident angle for the first etching with respect to the sensor with the aim of removing the re-deposited substance that deposited on the side wall surface of the magneto-resistance film 3 in the track width direction during the first etching. At this time, the area 10 is surrounded by the magneto-resistance film 3 and the resist mask 8 on the left side and by the refill film along sensor height direction 6 on the back side in FIG. 6(b), and the possible incidence of the ion beam is limited only to two directions on the right side and the front side in the figure, and thus, the removal of the re-deposited substance becomes insufficient.

Next, a case where the track fabrication step is carried out before the sensor height fabrication step (FIG. 3(b)) is described. In this case, an area shadowed by the refill film along track width direction 1 is generated in etching for the sensor height fabrication. FIG. 7 is a schematic diagram in which appearances of the vicinity of the back portion in the sensor height direction before the first etching (FIG. 7(a)) and after the first etching (FIG. 7(b)) for the sensor height fabrication after the track fabrication in the case where the track fabrication step is carried out before the sensor height fabrication step are viewed from the opposite side of the air bearing surface. In FIG. 7, the back side (+Y direction) corresponds to the direction serving as the air bearing surface of the magnetic reading head. After the track fabrication, the magneto-resistance film 3, the refill film along track width direction 1, and a side shield film or the longitudinal bias layer 5 are masked by a resist 11 as shown in FIG. 7(a), and then areas other than the masked area are removed by the first etching as shown in FIG. 7(b).

At this time, there is a difference in the etching rates between the magneto-resistance film 3 and the refill film along track width direction 1 in the first etching, and therefore, a wall of the refill film along track width direction 1 is formed on the back side (−Y direction) of the magneto-resistance film 3 in the sensor height direction as shown in FIG. 7(b). Owing to this wall of the refill film along track width direction 1, an area 12 surrounded by the magneto-resistance film 3, the side shield film or the longitudinal bias layer 5, the resist mask 11, and both sides of the refill film along track width direction 1 becomes hard to be irradiated by ion beam during the second etching to be performed hereafter. The second etching is carried out at an incident angle more oblique than the incident angle for the first etching with respect to the magneto-resistance film 3 with the aim of removing the re-deposited substance that deposited on the side wall surface of the magneto-resistance film 3 in the sensor height direction during the first etching. At this time, the side wall surface of the magneto-resistance film 3 in the sensor height direction shown in FIG. 7(b) is surrounded by the magneto-resistance film 3, the longitudinal bias layer 5, the resist mask 11, and the refill film along track width direction 1, and therefore, a situation that makes the ion beam hard to enter is brought about, resulting in insufficient removal of the re-deposited substance.

As just described, the fabrication process of the conventional magnetic reading head is problematic in that, in the two-step etching to remove the re-deposited substance that deposits on the side wall surface of the magneto-resistance film at the time of patterning by etching the magneto-resistance film in the track width direction or the sensor height direction, an area where ion beam is hard to enter is generated at the time of the second etching and that removal of the re-deposited substance becomes insufficient, resulting in making the output of the magnetic reading head smaller.

The present invention aims to solve the problem of the conventional technology and to provide a high output magnetic reading head free from re-deposited substance on the side wall surface of a magneto-resistance film and its fabrication process.

In order to solve the problem that the area hard to allow the incidence of ion beam in the second etching is generated and the removal of the re-deposited substance is rendered insufficient, a refill film that is fabricated first of the refill film along track width direction or the refill film along sensor height direction may be made of a material with a fast etching rate such as SiO₂. However, when such a material was used, it was found that characteristics of magneto-resistance film were deteriorated by a thermal treatment in the process as described later.

Hence, the refill film is fabricated in multi-layer films, and materials for the refill film are selected so that the etching rates of layers other than the layer in contact with the magneto-resistance film may become faster than the etching rate of the layer in contact with the magneto-resistance film. Namely, as to the refill film that is fabricated first of the refill film along track width direction or the refill film along sensor height direction, the layer in contact with the magneto-resistance film is formed of a material that is slow in etching rate but possible to minimize deterioration of characteristics due to thermal treatment, and a layer(s) other than the layer in contact with the magneto-resistance film is formed of a material that is fast in etching rates. In this way, the area in a situation that makes the incidence of ion beam hard in the second etching is eliminated while the deterioration of characteristics due to thermal treatment is minimized, resulting in sufficient removal of the re-deposited substance.

According to the present invention, it is possible to realize a high-output magnetic reading head with less leak of sensing current because re-deposited substance that deposited on the wall surface of the magneto-resistance film in the etching step of the fabrication process can be readily removed. Moreover, it is possible to realize a magnetic read/write apparatus with high recording density by mounting the magnetic reading head of the present invention.

### BRIEF DESCRIPTION OF THE DRAWINGS

FIG. 1 is a schematic diagram of a cross section in the track width direction of a magnetic reading head in CPP mode;

FIG. 2 is a schematic diagram of a cross section in the sensor height direction of the magnetic reading head in CPP mode;

FIG. 3 shows flow charts illustrating fabrication processes of the magnetic reading head in CPP mode;

FIG. 4 shows schematic diagrams illustrating cross sections in the track width direction or the sensor height direction that represent a fabrication process of a conventional magnetic reading head;

FIG. 5 shows schematic diagrams to explain two-step etching;

FIG. 6 shows schematic diagrams to explain a problem of a conventional magnetic reading head in CPP mode;

FIG. 7 shows schematic diagrams to explain another problem of the conventional magnetic reading head in CPP mode;

FIG. 8 is a graph showing the dependence of etching rate of each material on ion incidence angle;

FIG. 9 is a graph showing changes in resistance of magneto-resistance elements before and after thermal treatment;

FIG. 10 is a graph showing changes in MR ratio of the magneto-resistance elements before and after thermal treatment;

FIG. 11 is a schematic diagram of a cross section in the sensor height direction of a magnetic reading head according to Embodiment 1 of the present invention;

FIG. 12 shows schematic diagrams of cross sections in the sensor height direction that represent a fabrication process of the magnetic reading head according to Embodiment 1 of the present invention;

FIG. 13 is a schematic cross section of a magnetic reading head mounting a writer element for longitudinal recording;

FIG. 14 is a schematic cross section of a magnetic reading head mounting a writer element for perpendicular recording;

FIG. 15 is a schematic diagram of a magnetic read/write apparatus;

FIG. 16 shows a graph comparing outputs from the magnetic reading head according to Embodiment 1 of the present invention and the conventional magnetic reading head;

FIG. 17 is a schematic diagram of a cross section in the track width direction of a magnetic reading head according to Embodiment 2 of the present invention;

FIG. 18 shows schematic diagrams of cross sections in the track width direction that represent a fabrication process of the magnetic reading head according to Embodiment 2 of the present invention;

FIG. 19 shows a graph comparing outputs from the magnetic reading head according to Embodiment 2 of the present invention and the conventional magnetic reading head;

FIG. 20 is a schematic diagram of a cross section in the sensor height direction of a magnetic reading head in which only part of a magneto-resistance film is arranged so as to be exposed at an air bearing surface; and

FIG. 21 is a schematic diagram of a cross section in the sensor height direction of a magnetic reading head in which a magneto-resistance film is arranged at a place distant from the air bearing surface.

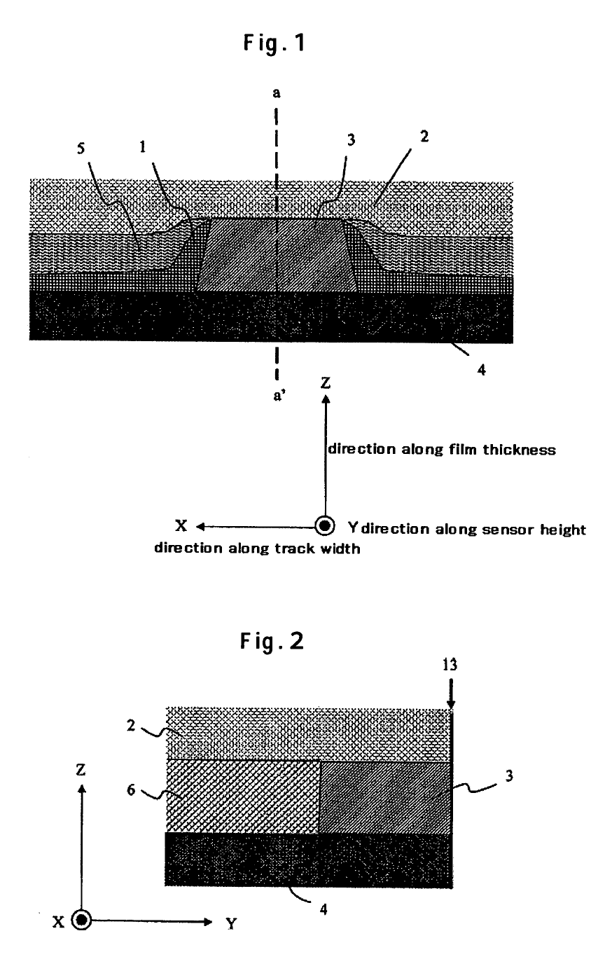

### DETAILED DESCRIPTION OF THE INVENTION

The reason why an area hard to allow the incidence of ion beam is generated at the time of the second etching to remove the re-deposited substance on the side wall surface of the magneto-resistance film includes the fact that the etching rate during the first etching of alumina that is generally used for a refill film is slower than the etching rate of each metal constituting the magneto-resistance film. Accordingly, etching rates of prevalent materials in etching with Ar ion were compared in order to select a candidate for the refill film material with faster etching rate.

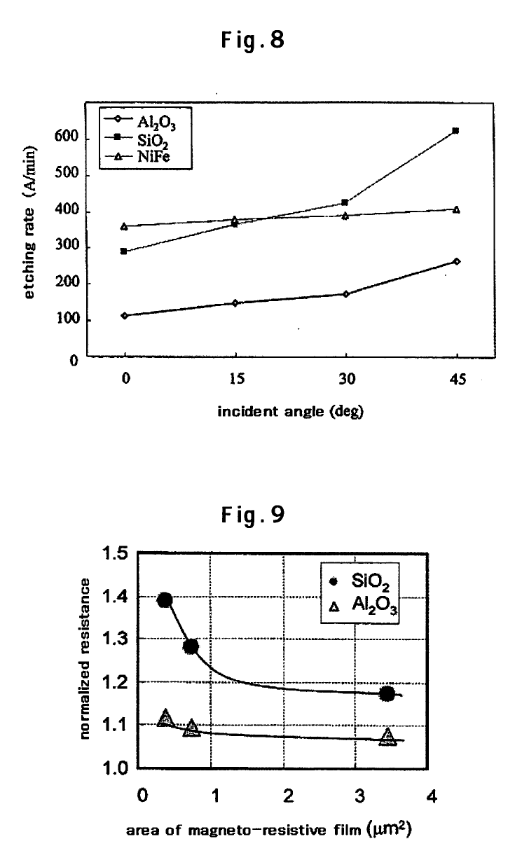

FIG. 8 shows the result of the comparison of etching rates measured at an applied voltage of 350 V, an ion current of 0.20 A, and an arc voltage of 70 V. In FIG. 8, the horizontal axis indicates the incident angle of the ion beam with respect to the normal direction to an etching sample, and the vertical axis indicates the etching rate of each material. The incident angle of the ion beam is generally from 0 to 20 degrees during the first etching. Within this range, it is found that the etching rate of alumina (Al₂O₃) is about one third compared to that of a metal such as nickel-iron alloy that is used for the magneto-resistance film. On the other hand, the etching rate of silicon oxide (SiO₂) is nearly the same as that of nickel-iron. From this, it appears that the ion beam becomes easier to be irradiated and the re-deposited substance becomes easier to be removed by using silicon oxide (SiO₂) for the refill film because difference in level and wall resulting from the difference in etching rates are not formed and an area where the ion beam is cut off by the refill film during the second etching is hard to be generated.

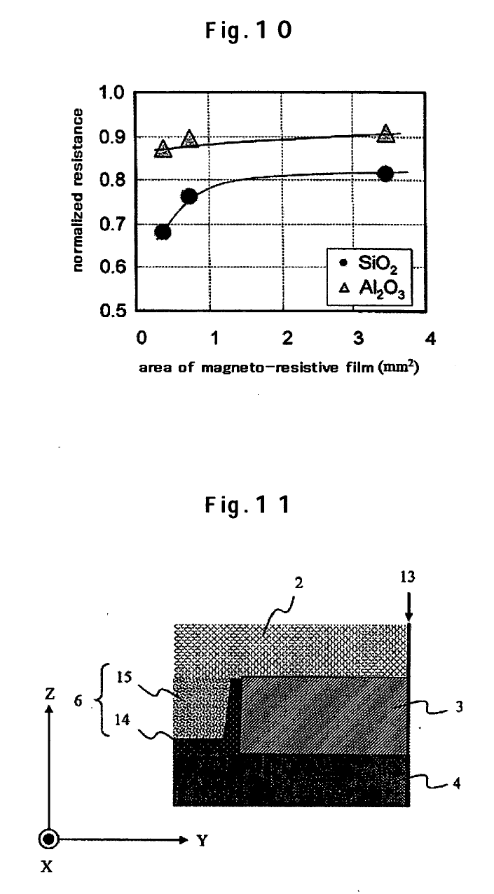

Since the refill film is in contact with the side wall surface of the magneto-resistance film in a magnetic reading head in CPP mode, it is necessary to study the effect of a refill film material on characteristics of the magneto-resistance film. Here, changes in resistance and MR ratio of magneto-resistance elements were studied before and after thermal treatment at 250 degrees C. for 3 hours assuming the thermal treatment during the fabrication process of the magnetic reading head. FIG. 9 and FIG. 10 show these experimental results. It should be noted that a TMR film is used for the magneto-resistance film in these experiments. The vertical axis in these figures represents the value normalized by the value before the thermal treatment for the value after the thermal treatment with respect to each of resistance and MR ratio. The horizontal axis represents the area of the magneto-resistance element. As shown in FIG. 9 and FIG. 10, it can be said that alumina (Al₂O₃) is more effective in lessening deterioration of characteristics of the magneto-resistance film caused by heat compared to silicon oxide (SiO₂) and its effect is prominent particularly when the area of the magneto-resistance film is small. From this, it can be said that alumina (Al₂O₃) is preferably used for the refill film in order to lessen the deterioration of characteristics due to heat.

From the results of the above two experiments, it is found that there are the following problems respectively when Al₂O₃ or SiO₂ is used for the refill film. When alumina (Al₂O₃) is used, the deterioration of characteristics of the magneto-resistance film due to heat can be minimized. However, an area hard to allow the incidence of the ion beam to the wall surface of the magneto-resistance film is generated at the time of the second etching to remove the re-deposited substance, since etching rate is slow and thus the refill film limits the incident direction of the ion beam as described above. On the other hand, when silicon oxide (SiO₂) is used, the deterioration of characteristics of the magneto-resistance film due to heat is large, although an area hard to allow the incidence of ion beam at the time of the second etching is difficult to be generated because of a small difference of its etching rate from that of the magneto-resistance film.

In order to solve this problem, the refill film may be fabricated with multi-layer films, among which layers other than the layer in contact with the magneto-resistance film are composed of a material having an etching rate faster than that of the layer in contact with the magneto-resistance film and the layer in contact with the magneto-resistance film is composed of a material that is little affected in terms of the characteristics of the magneto-resistance film at the time of the thermal treatment. For example, among the refill films composed of multi-layer films, layers other than the layer in contact with the magneto-resistance film may be composed of silicon oxide (SiO₂) and the layer in contact with the magneto-resistance film may be composed of alumina (Al₂O₃), thereby minimizing the problem of deterioration of characteristics of the magneto-resistance film as well as forming a structure in which an area hard to allow the incidence of the ion beam at the time of the second etching is difficult to be generated.

Embodiments of the present invention are explained next with reference to the accompanying drawings.

### Embodiment 1

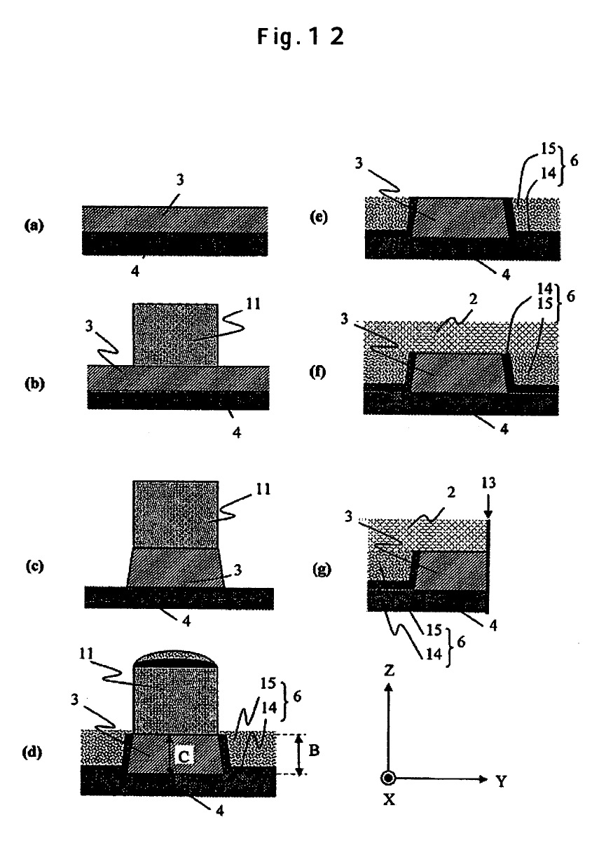

FIG. 11 is a cross section in the sensor height direction showing a sensor portion of one example of the magnetic reading head according to the present invention. FIG. 12 is an explanatory drawing of its fabrication process and shows cross sections in the sensor height direction in each step.

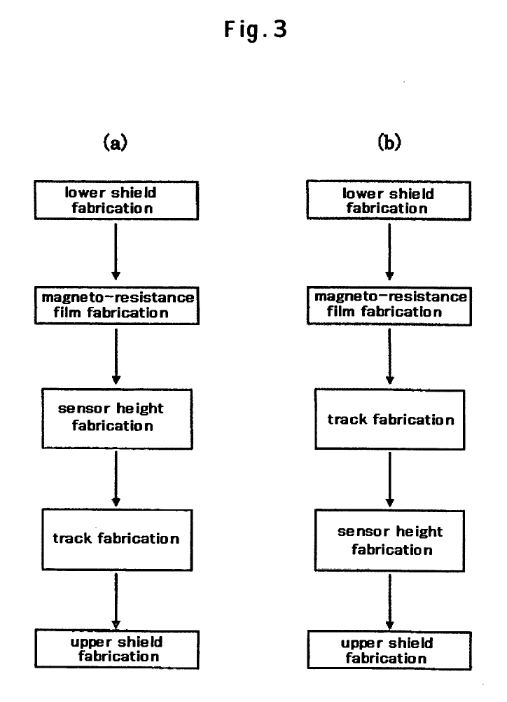

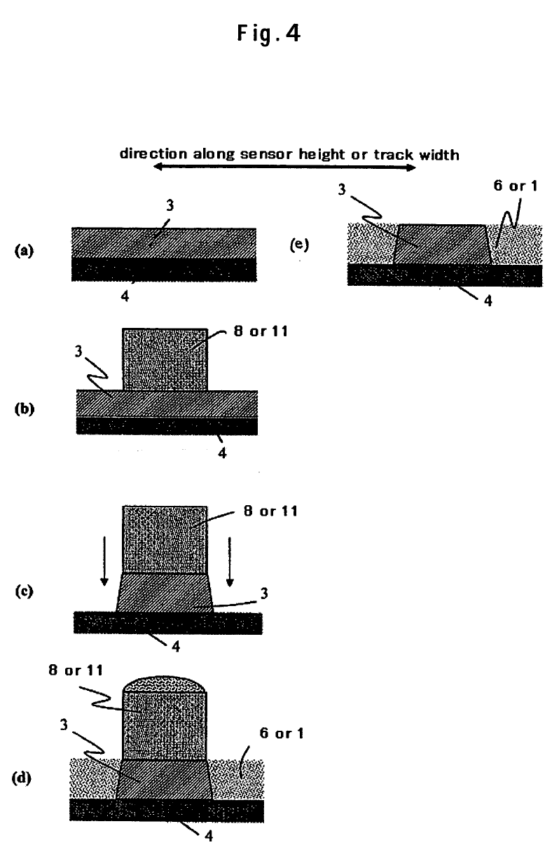

The fabrication process of the magnetic reading head having the structure shown in FIG. 11 is explained using FIG. 12. It should be noted that the magnetic reading head in the present embodiment is fabricated according to the method in which the step of the sensor height fabrication is carried out before the step of the track width fabrication as shown in FIG. 3(a). First, the substrate surface composed of alumina titanium carbide (AlTiC) or the like is coated with an insulator such as Al₂O₃ and then subjected to precision polishing by chemical mechanical polish (CMP) or the like to fabricate the lower shield layer 4. This is fabricated by patterning a film composed of nickel-iron alloy prepared by, for example, sputtering, ion beam sputtering, or plating in a predetermined shape. By allowing Al₂O₃ to develop on top of this and subjecting to CMP, the substrate surface becomes a surface of the lower shield layer 4 and Al₂O₃ planarized. Further, a lead electrode film (not illustrated) is formed at a portion distant from the area where the magneto-resistance film 3 is fabricated at a later step. This is, for example, composed of a stack film of Ta, Au, and Ta.

On top of this lower shield layer 4, the magneto-resistance film 3 is fabricated, for example, by sputtering or ion beam sputtering (FIG. 12(a)). The magneto-resistance film is made up, for example, by being provided with a pinned layer composed of a layer containing a ferromagnetic material of cobalt-iron alloy, an intermediate layer composed of Al—O, Cu, or the like, and a free layer composed of a layer containing nickel-iron alloy, cobalt-iron alloy, or the like.

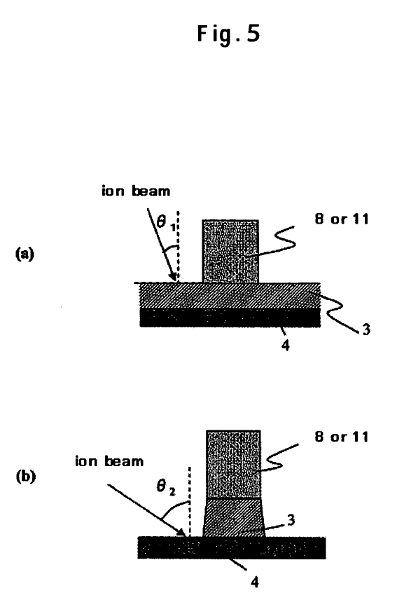

Then, fabrication in the sensor height direction is carried out. First, a resist is coated over the magneto-resistance film 3 and exposed to light using steppers/scanners, followed by patterning to a desired shape by developing this in a developing solution to provide a lift-off mask 11 (FIG. 12(b)). This lift-off mask 11 may be coated with poly dimethyl glutamic imide on the back side of the resist and may be formed in a double-layer structure that is subjected to patterning together with the resist. Next, dry etching such as ion beam etching and reactive ion etching (RIE) is carried out on the magneto-resistance film 3, and a pattern in the sensor height direction is formed by the etching (FIG. 12(c)). Following this etching, ion beam etching is again carried out at a second incident angle that is more oblique than the incident angle in the first etching with respect to the substrate as shown in FIG. 5, thereby allowing the re-deposited substance that deposited on the element wall surface during the first etching to be removed. The incident angle for the second etching is desirably from about 60 degrees to about 80 degrees. The fabrication in the sensor height direction may be performed by repeating the first etching and the second etching alternately a plurality of times, or a technique different from those for the first etching and the second etching or etching using a different ion incidence angle may be adopted between the first etching and the second etching.

Subsequently, the refill film along sensor height direction 6 composed of multi-layers is fabricated by sputtering or ion beam sputtering. It is desirable to design the composition and film thickness of the refill film along sensor height direction 6 such that the depths etched for the refill film along sensor height direction 6 and the magneto-resistance film 3 become equal in the first etching of the etching steps for the track fabrication. This is because, as described above, an area hard to allow the incidence of ion beam at the time of the second etching to remove re-deposition in the track fabrication step to be performed hereafter is prevented from being generated.

A first refill film along sensor height direction 14 in direct contact with the magneto-resistance film 3 of the refill films along sensor height direction 6 is an insulating film, which is most desirably fabricated with alumina in order to minimize the deterioration of characteristics of the magneto-resistance film due to heat described above.

Of the refill films along sensor height direction 6, a second refill film along sensor height direction 15 that is fabricated on the first refill film along sensor height direction 14 may be either an insulating material or metal. However, it is necessary for the second refill film along sensor height direction to be made of a material with a faster etching rate during the first etching in the track fabrication step compared to that of the first refill film along sensor height direction 14 so that an area hard to allow the incidence of ion beam at the time of the second etching to remove the re-deposition in the track fabrication step to be performed hereafter is prevented from being generated, as described above.

For example, when ion beam etching is considered for the first etching in the track fabrication step, it is important that the hardness of the second refill film along sensor height direction 15 is lower compared with the hardness of the first refill film along sensor height direction 14 because the magnitude of rate of etching depends on the hardness. That is, the first refill film along sensor height direction 14 is desirably made of an insulating material with higher hardness, and specifically, alumina, titanium oxide, or the like is conceivable. The hardness can be compared, for example, by Vickers hardness. When alumina is employed for the first refill film along sensor height direction 14 in consideration of the deterioration of characteristics of the magneto-resistance film due to heat described above, specific materials conceivable for the second refill film along sensor height direction 15 include nickel oxide, silicon oxide, silicon nitride, aluminum nitride, zirconium oxide, tantalum oxide, and the like. In addition, a mixture of alumina with any material of nickel oxide, silicon oxide, silicon nitride, aluminum nitride, zirconium oxide and tantalum oxide, a mixture of silicon oxide with any material of nickel oxide, silicon nitride, aluminum nitride, zirconium oxide, and tantalum oxide, or the like can also serve as a candidate for the second refill film along sensor height direction 15. Further, a metal such as nickel-iron alloy, Rh, Ru, Au, Cr, nickel-chromium alloy, nickel-chromium-iron alloy, Cu, or Ta may also be used.

Furthermore, when reactive etching by CO+NH₃ gas or chlorinated gas is considered for the first etching in the track fabrication step, it is important that the vapor pressure of the reaction product of the second refill film along sensor height direction 15 is higher compared with the vapor pressure of the reaction product of the first refill film along sensor height direction 14 because the magnitude of rate of etching depends on the vapor pressure of the reaction products. For example, when etching by a carbonyl compound gas is employed, the vapor pressure of the carbonyl compound of Si, Ni, Fe, or the like is higher by five to six orders of magnitude compared with the vapor pressure of the carbonyl compound of Al, and therefore, alumina for the first refill film along sensor height direction 14 and silicon oxide, nickel oxide, nickel-iron alloy, or the like for the second refill film along sensor height direction 15 may be used. And when etching by chlorinated gas is employed, alumina for the first refill film along sensor height direction 14 and a silicic compound such as silicon oxide or silicon nitride for the second refill film along sensor height direction 15 may be used because the vapor pressures of aluminum chloride and silicon chloride are ca. 1×10⁻² Torr and ca. 1×10² Torr, respectively, at room temperature.

Although the refill film along sensor height direction composed of double layers has been mentioned in the foregoing, an additional multi-layer structure may be formed by fabricating further a third, fourth, . . . refill films on the second refill film along sensor height direction 15. However, all of these third, fourth refill films should be made of materials with faster etching rates during the first etching in the track fabrication step compared with that of the first refill film along sensor height direction 14 as in the case of the second refill film along sensor height direction 15. In addition, it is desired that the thickness B of the refill film along sensor height direction 6 shown in FIG. 12(d) is close to the thickness C of the magneto-resistance film 3 shown in FIG. 12(d) in order to facilitate pattern formation in the track fabrication step to be carried out hereafter. Next, the lift-off mask 11 is removed using an organic solvent to make up a shape as shown in FIG. 12(e).

After this step, the track fabrication is carried out (not illustrated). At the time of the track fabrication, a resist mask is made using a resist or a resist and PMGI as in the case of the sensor height fabrication, and the magneto-resistance film 3 is subjected to dry etching such as ion beam etching or reactive ion etching (RIE) to complete the track fabrication by etching. Following this etching, etching is carried out at a second incident angle that is more oblique than the incident angle in the first etching with respect to the substrate, thereby allowing the re-deposited substance that deposited on the sensor side wall surface during the first etching to be removed.

When ion beam etching is performed, the ion incidence angle during the first etching is desired to be from about 0 to 45 degrees. Even if either ion beam etching or reactive ion etching (RIE) is chosen for the first etching, it is desirable that ion beam etching at an incident angle set from about 60 degrees to 80 degrees is used for the second etching. In addition, the track fabrication may be performed by repeating the first etching and the second etching alternately a plurality of times, and also a technique different from those for the first etching and the second etching or etching using a different ion incidence angle may be adopted between the first etching and the second etching.

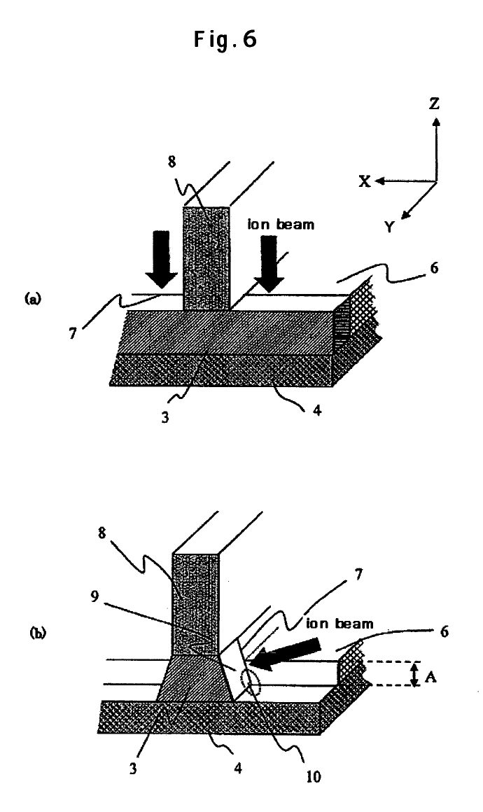

At this time, the difference in level shown in FIG. 6 is eliminated or made small, since the refill film along sensor height direction 6 was fabricated in a multi-layer structure and the second refill film along sensor height direction 15 was fabricated of a material with an etching rate faster than that of the first refill film along sensor height direction 14; thus an area where an ion beam is blocked by the refill film along sensor height direction 6 and hard to be irradiated like the area 10 shown in FIG. 6 does not exist and the ion beam is fully irradiated on the sensor side wall surface during the second etching, thereby fully carrying out the removal of the re-deposited layer.

After etching the magneto-resistance film 3, the refill film along track width direction 1 is fabricated. This refill film along track width direction 1 may or may not be in a multi-layer structure as long as the material in direct contact with the magneto-resistance film 3 is an insulating material. Of the refill films along track width direction 1, at least the layer in direct contact with the magneto-resistance film 3 is desired to be composed of alumina. Although it is possible to further fabricate a longitudinal bias layer or side shield layer 5 on the refill film along track width direction 1, this longitudinal bias layer or side shield layer 5 is not necessarily required. Finally, the resist mask is removed using an organic solvent to complete fabrication in the track width direction.

Subsequently, an upper shield layer 2 composed of a soft magnetic material is fabricated on the magneto-resistance film 3 (FIG. 12(f)). At the time of fabricating this upper shield layer 2, a metal such as Ta or NiCr as a foundation layer may be fabricated into a film on the magneto-resistance film 3, followed by fabricating the upper shield layer 2. Then, after undergoing a step of building up lead terminals or a step of fabricating a writer element to record information on a medium, an air bearing surface 13 is fabricated in a slider fabrication step to provide the magnetic reading head according to the present invention (FIG. 12(g)).

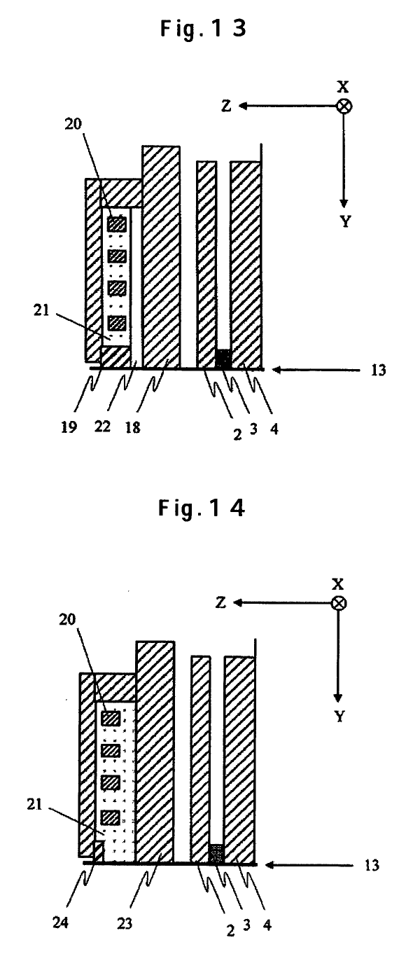

FIG. 13 and FIG. 14 are schematic cross sections of magnetic heads in which the magnetic reading head of the present embodiment and a writer element are combined. FIG. 13 shows a magnetic head for longitudinal recording and FIG. 14 shows a magnetic head for perpendicular recording. In the case of the magnetic head for longitudinal recording, the writer element is comprised of a lower pole 18, an upper pole 19, coils 20, a coil insulator 21, and a gap 22 as shown in FIG. 13. And in the case of the magnetic head for perpendicular recording as shown in FIG. 14, a single pole type head comprised of an adjunct pole 23, a main pole 24, coils 20, and a coil insulator 21 is used for the writer element.

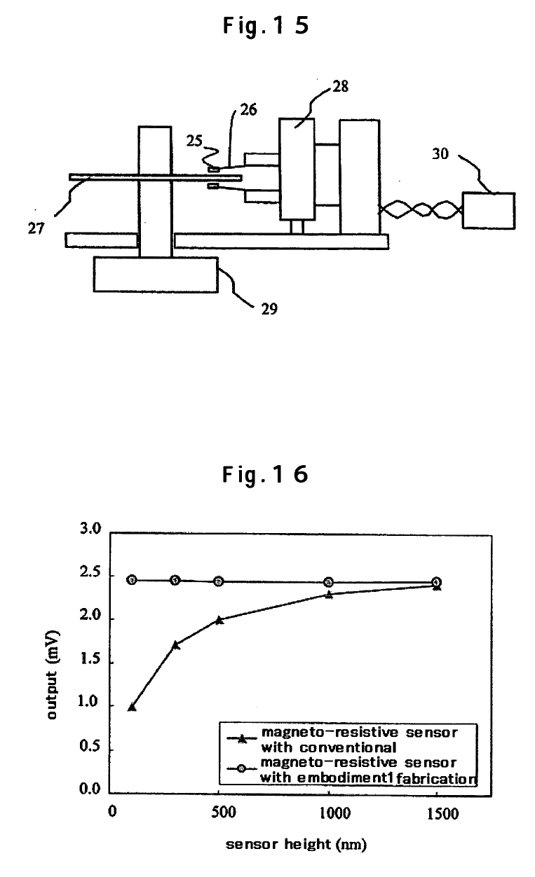

FIG. 15 is a schematic diagram of the magnetic read/write apparatus provided with a magnetic head 25 mounting the magnetic reading head according to an embodiment of the present invention. This magnetic read/write apparatus is provided with magnetic recording medium 27 rotationally driven by a motor 29, a magnetic head 25 mounting a writing head and a reading head, a voice coil motor (actuator) 28, and a signal processing circuit 30. The magnetic head 25 is attached to the tip of gimbals 26 and driven relative to the magnetic recording medium 27 by the voice coil motor 28 to be positioned above a desirable track. Writing signals transmitted from a host are sent to the writing head of the magnetic head 25 via the signal processing circuit 30 and recorded on the magnetic recording medium 27 by allowing magnetization flip to occur. Further, leaked magnetic field arising from magnetization which is recorded on the magnetic recording medium 27 is detected by the reading head of the magnetic head 25, and the detected signals are processed by the signal processing circuit 30 and then transmitted to the host as reading signals.

Next, a comparative experiment between the magnetic reading head of the present embodiment and a conventional magnetic reading head was carried out. For the magnetic reading head of the present embodiment, the refill film along sensor height direction 6 was in a double-layer structure. Specifically, alumina with Vickers hardness of 1750 was used for the first refill film along sensor height direction 14 in direct contact with the magneto-resistance film 3, and SiO₂ with Vickers hardness of 650 was used for the second refill film along sensor height direction 15 fabricated on the first refill film along sensor height direction 14. Ion beam etching was used in the first etching for each of the sensor height fabrication and the track fabrication. The conventional magnetic reading head was fabricated in the same manner as for the magnetic reading head of the present embodiment except that the refill film along sensor height direction 6 was made in a single layer structure of alumina. Note that a TMR film is used for the magneto-resistance film 3.

In this comparative experiment, a maximum magnetic field of 10 kOe was applied at an applied voltage of 20 mV to determine the transfer-curve. The outputs from each of the magnetic reading heads are compared in FIG. 16. It is found that the output from the conventional magnetic reading head decreases as the sensor height becomes smaller. This is interpreted as the result that re-deposited layer remains in the area shown by the area 10 in FIG. 6 and sensing current is leaking. Namely, this is because the current component flowing through the re-deposited area that does not contribute to the output of the sensing current becomes larger as the sensor height becomes smaller. On the other hand, it is found that the output from the magnetic reading head of the present embodiment is approximately constant irrespective of the sensor height.

It is expected that the sensor height becomes smaller and smaller from now on with the aim of improvement in recording density in the magnetic read/write apparatus. This is because a magnetic reading head that retains a necessary output even if the track width and the inter-shield distance are made small with the aim of improving MR ratio and recording density by arranging the magneto-resistance film 3 only in the vicinity of the air bearing surface 13 that is most magnetically sensitive is to be realized. When re-deposited layer exists in the area shown by the area 10 in FIG. 6, the current that dos not contribute to magnetic resistance change becomes larger as the sensor height is made smaller for the above aim, and thus the output as a sensor becomes smaller. From the result shown in FIG. 16, the magnetic reading head according to the present embodiment proves to be the one in which the loss of the sensing current is small and a high output is realized even when the sensor height is made small.

It should be noted that the foregoing was explained using a tunneling magneto-resistance film comprising a pinned layer composed of a layer containing a ferromagnetic material of cobalt-iron alloy, an insulating layer composed of Al—O or the like, and a free layer composed of a layer containing nickel-iron alloy, cobalt-iron alloy, or the like for the magneto-resistance film 3. However, this is merely one example and the magneto-resistance film is not limited to this. A giant magneto-resistance layer comprising the pinned layer composed of a layer containing a ferromagnetic material of cobalt-iron alloy, an intermediate layer composed of Cu or the like, and the free layer composed of a layer containing nickel-iron alloy, cobalt-iron alloy, or the like may also be used. Alternatively, for example, a magneto-resistance film in which a high polarizability material is used for the pinned layer or the free layer, a magneto-resistance film in which a current screen layer is provided to the pinned layer, the intermediate layer, or the free layer, further a magneto-resistance film with magnetic semiconductor, a magneto-resistance film utilizing diffusion and accumulation phenomena of polarized spin, or the like can also be used. As long as the device allows sensing current to flow in the direction approximately perpendicular to the film surface of a material constituting the magneto-resistance film, the effect of the present invention remains unchanged.

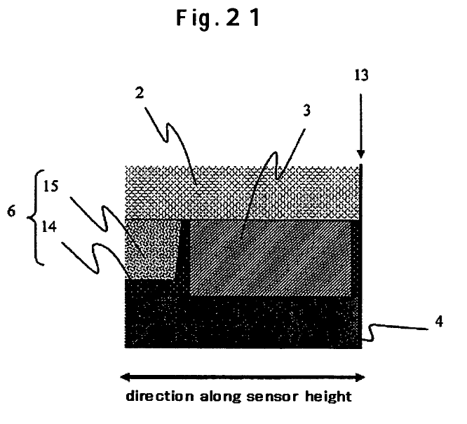

Further, the magnetic reading head in which the magneto-resistance film 3 was arranged so as to be exposed at the air bearing surface 13 was mentioned above. However, a similar effect can also be obtained by a magnetic reading head in which only part of the magneto-resistance film 3 is arranged so as to be exposed at the air bearing surface 13 as shown in FIG. 20 or a magnetic reading head in which the magneto-resistance film 3 is arranged at a place distant from the air bearing surface as shown in FIG. 21.

### Embodiment 2

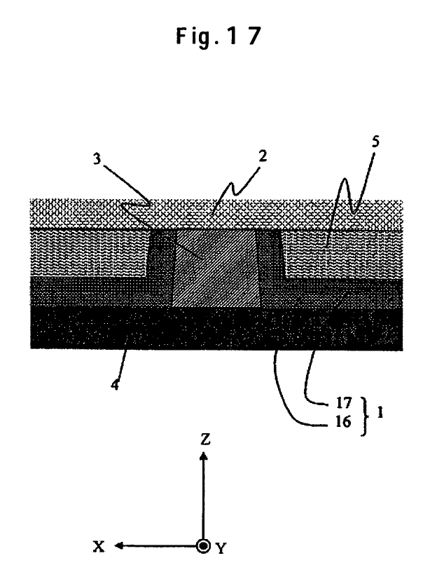

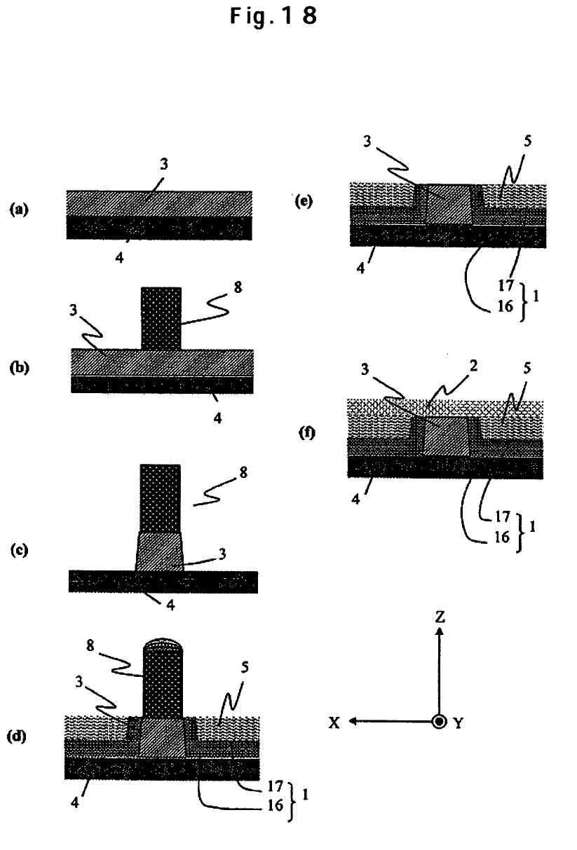

FIG. 17 is a cross section in the track width direction showing a sensor portion of another example of the magnetic reading head according to the present invention. FIG. 18 is an explanatory drawing of its fabrication process and shows cross sections in the track width direction in each step.

The fabrication process of the magnetic reading head having the structure shown in FIG. 17 is explained using FIG. 18. First, the substrate surface composed of alumina titanium carbide or the like is coated with an insulator such as Al₂O₃ and then subjected to precision polishing by chemical mechanical polish (CMP) or the like to fabricate the lower shield layer 4. This is fabricated by patterning a film composed of nickel-iron alloy prepared by, for example, sputtering, ion beam sputtering, or plating in a predetermined shape. By allowing Al₂O₃ to develop on top of this and subjecting to CMP, the substrate surface becomes a surface of the lower shield layer 4 and Al₂O₃ planarized. Further, a lead electrode film (not illustrated) is formed at a portion distant from the area where the magneto-resistance film 3 is fabricated at a later step. This is, for example, composed of a stack film of Ta, Au, and Ta.

On top of this lower shield layer 4, the magneto-resistance film 3 is fabricated by, for example, sputtering or ion beam sputtering (FIG. 18(a)). The magneto-resistance film 3 is made up, for example, by being provided with a pinned layer composed of a layer containing a ferromagnetic material of cobalt-iron alloy, an intermediate layer composed of Al—O, Cu, or the like, and a free layer composed of a layer containing nickel-iron alloy, cobalt-iron alloy, or the like.

Then, fabrication in the track width direction is carried out. First, a resist is coated over the magneto-resistance film 3 and exposed to light using steppers/scanners, followed by patterning to a desired shape by developing this in a developing solution to provide a lift-off mask 8 (FIG. 18(b)). This lift-off mask 8 may be coated with poly dimethyl glutamic imide on the back side of the resist and may be formed in a double-layer structure that is subjected to patterning together with the resist. Next, dry etching such as ion beam etching and reactive ion etching (RIE) is carried out on the magneto-resistance film 3, and a pattern in the track width direction is formed by the etching (FIG. 18(c)). Following this etching, ion beam etching is again carried out at a second incident angle with more oblique incident angle, thereby allowing the re-deposited substance that deposited on the sensor wall surface during the first etching to be removed. The incident angle for the second etching is desirably from about 60 degrees to about 80 degrees. The fabrication in the track width direction may be performed by repeating the first etching and the second etching alternately a plurality of times, or a technique different from those for the first etching and the second etching or etching using a different ion incidence angle may be adopted between the first etching and the second etching.

Subsequently, the refill film along track width direction 1 composed of multi-layers is fabricated by sputtering or ion beam sputtering. It is desirable to design the composition and film thickness of the refill film along track width direction 1 such that the depths etched for the refill film along track width direction 1 and the magneto-resistance film 3 become equal in the first etching of the etching steps for the sensor height fabrication. This is because, as described above, an area hard to allow the incidence of ion beam at the time of the second etching to remove the re-deposition in the sensor height fabrication step to be performed hereafter is prevented from being generated.

A first refill film along track width direction 16 in direct contact with the magneto-resistance film 3 of the refill films along track width direction 1 is an insulating film, which is most desirably fabricated with alumina in order to minimize the deterioration of characteristics of the magneto-resistance film due to heat described above.

Of the refill films along track width direction 1, a second refill film along track width direction 17 that is fabricated on the first refill film along track width direction 16 may be either an insulating material or metal. However, it is necessary for the second refill film along sensor height direction to be made of a material with a faster etching rate during the first etching in the sensor height fabrication step compared to that of the first refill film along track width direction 16 so that an area hard to allow the incidence of ion beam at the time of the second etching to remove the re-deposited substance in the sensor height fabrication step to be performed hereafter is prevented from being generated, as described above.

For example, when ion beam etching is considered for the first etching in the track fabrication step, it is important that the hardness of the second refill film along track width direction 17 is lower compared with the hardness of the first refill film along track width direction 16 because the magnitude of rate of etching depends on the hardness. That is, the first refill film along track width direction 16 is desirably made of an insulating material with higher hardness, and specifically, alumina, titanium oxide, or the like is conceivable. The hardness can be compared, for example, by Vickers hardness. When alumina is employed for the first refill film along track width direction 16 in consideration of the deterioration of characteristics of the magneto-resistance film due to heat described above, specific materials conceivable for the second refill film along track width direction 17 include nickel oxide, silicon oxide, silicon nitride, aluminum nitride, zirconium oxide, tantalum oxide, and the like. In addition, a mixture of alumina with any material of nickel oxide, silicon oxide, silicon nitride, aluminum nitride, zirconium oxide and tantalum oxide, a mixture of silicon oxide with any material of nickel oxide, silicon nitride, aluminum nitride, zirconium oxide, and tantalum oxide, or the like can also serve as a candidate for the second refill film along track width direction 17. Further, a metal such as nickel-iron alloy, Rh, Ru, Au, Cr, nickel-chromium alloy, nickel-chromium-iron alloy, Cu, or Ta may also be used.

Furthermore, when reactive etching by CO+NH₃ gas or chlorinated gas is considered for the first etching in the track fabrication step, it is important that the vapor pressure of the reaction product of the second refill film along track width direction 17 is higher compared with the vapor pressure of the reaction product of the first refill film along track width direction 16 because the magnitude of rate of etching depends on the vapor pressure of the reaction products. For example, when etching by CO+NH₃ gas is employed, the vapor pressure of the carbonyl compound of Si, Ni, Fe, or the like is higher by five to six orders of magnitude compared with the vapor pressure of the carbonyl compound of Al, and therefore, alumina for the first refill film along track width direction 16 and silicon oxide, nickel oxide, nickel-iron alloy, or the like for the second refill film along track width direction 17 may be used. And when etching by carbonyl gas is employed, alumina for the first refill film along track width direction 16 and a silicic compound such as silicon oxide or silicon nitride for the second refill film along track width direction 17 may be used because the vapor pressures of aluminum chloride and silicon chloride are ca. 1×10⁻² Torr and ca. 1×10² Torr, respectively, at room temperature.

Although the refill film along track width direction composed of double layers has been mentioned in the foregoing, an additional multi-layer structure may be formed by fabricating further a third, fourth, . . . refill films on the second refill film along track width direction 17. However, all of these third, fourth refill films should be made of a material with a faster etching rate during the first etching in the sensor height fabrication step compared with that of the first refill film along track width direction 16 as in the case of the second refill film along track width direction 17. There may be cases where a longitudinal bias layer or a side shield film 5 is further fabricated over the refill film along track width direction 1 (FIG. 18 (d)). Next, the lift-off mask 8 is removed using an organic solvent to make up a shape as shown in FIG. 18(e).

After this step, the sensor height fabrication is carried out (not illustrated). At the time of the sensor height fabrication, a resist mask is made using a resist or a resist and PMGI as in the case of the direction along track width, and the magneto-resistance film 3 is subjected to dry etching such as ion beam etching or reactive ion etching (RIE) to complete the sensor height fabrication by etching. Following this etching, etching is carried out at a second incident angle with more oblique incident angle, thereby allowing the re-deposited substance that deposited on the sensor side wall surface during the first etching to be removed.

When ion beam etching is performed, the ion incidence angle during the first etching is desired to be from about 0 to 45 degrees. Even if either ion beam etching or reactive ion etching (RIE) is chosen for the first etching, it is desirable that ion beam etching at an incident angle set from about 60 degrees to 80 degrees is used for the second etching. In addition, the sensor height fabrication may be performed by repeating the first etching and the second etching alternately a plurality of times, or a technique different from those for the first etching and the second etching or etching using a different ion incidence angle may be adopted between the first etching and the second etching.

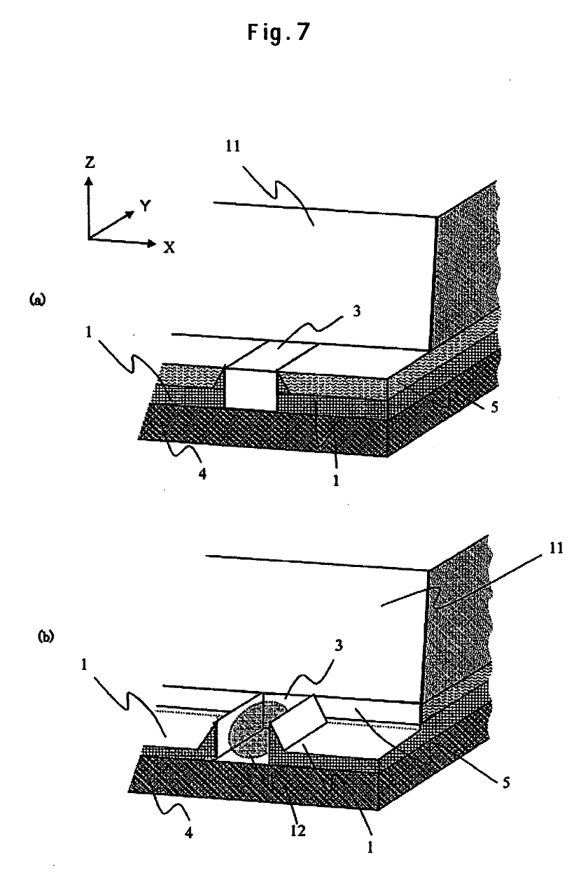

At this time, an area shadowed by the refill film like the area 12 shown in FIG. 7 does not exist, since the refill film along track width direction 1 was fabricated in a multi-layer structure and the second refill film along track width direction 17 was fabricated of a material with an etching rate faster than that of the first refill film along track width direction 16, and thus the ion beam is fully irradiated on the side wall surface of the magneto-resistance film 3 in the sensor height direction shown in FIG. 7 during the second etching, thereby fully carrying out the removal of the re-deposited layer.

After etching the magneto-resistance film 3, the refill film along sensor height direction 6 is fabricated. This refill film along sensor height direction 6 may or may not be in a multi-layer structure as long as the material in direct contact with the magneto-resistance film 3 is an insulating material. Of the refill films along sensor height direction 6, at least the layer in direct contact with the magneto-resistance film 3 is desired to be composed of alumina. Finally, the resist mask is removed using an organic solvent to complete fabrication in the sensor height direction.

Subsequently, the upper shield layer 2 composed of a soft magnetic material is fabricated on the magneto-resistance film 3 (FIG. 18(f)). At the time of fabricating this upper shield layer 2, a metal such as Ta or NiCr as a foundation layer may be fabricated into a film on the magneto-resistance film 3, followed by fabricating the upper shield layer 2. Then, after undergoing a step of building up lead terminals or a step of fabricating a writer element to record information on a medium, an air bearing surface 13 is fabricated in a slider fabrication step to provide the magnetic reading head according to the present embodiment.

The magnetic heads in which the magnetic reading head of the present embodiment and a writing head are combined are as shown in FIG. 13 and FIG. 14. The schematic diagram of the magnetic read/write apparatus provided with the magnetic head mounting the magnetic reading head of the present embodiment is as shown in FIG. 15. Since the details are the same as those described in the embodiment 1, these are omitted here.

Next, a comparative experiment between the magnetic reading head of the present embodiment and a conventional magnetic reading head was carried out. For the magnetic reading head of the present embodiment, the refill film along track width direction 1 was in a double-layer structure. Specifically, alumina with Vickers hardness of 1750 was used for the first refill film along track width direction 16 in direct contact with the magneto-resistance film 3, and SiO₂ with Vickers hardness of 650 was used for the second refill film along track width direction 17 fabricated on the first refill film along track width direction 16. And ion beam etching was used in the first etching for each of the sensor height fabrication and the track fabrication. The conventional magnetic reading head was fabricated in the same manner as for the magnetic reading head of the present embodiment except that the refill film along track width direction 1 was made in a single layer structure of alumina. Note that the TMR film is used for the magneto-resistance film 3.

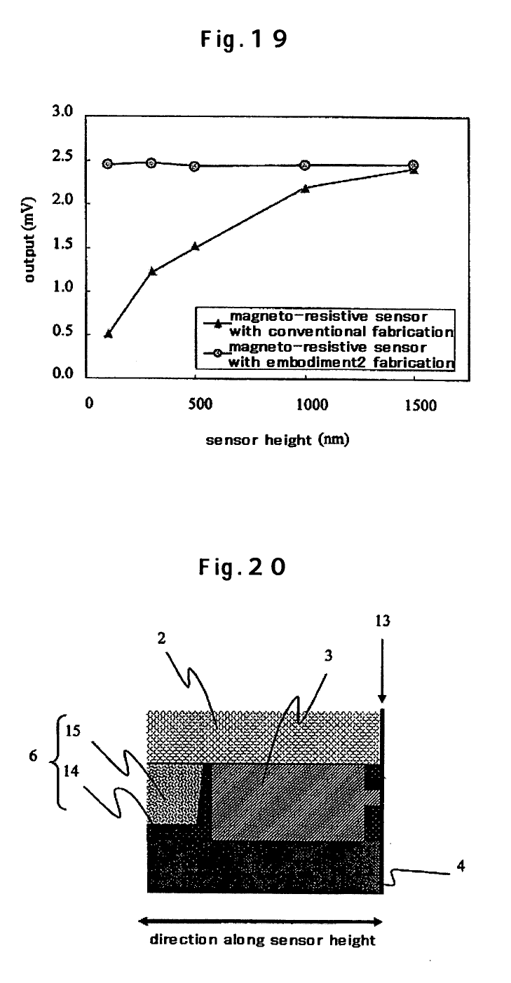

In this comparative experiment, a maximum magnetic field of 10 kOe was applied at an applied voltage of 20 mV to determine the transfer-curve. The outputs from each of the magnetic reading heads are compared in FIG. 19. It is found from FIG. 19 that the output from the conventional magnetic reading head decreases as the sensor height becomes smaller. This is interpreted as the result that re-deposited layer remains on the side wall surface of the magneto-resistance film 3 in the track width direction as shown in FIG. 7 and sensing current is leaking. Namely, this is because the current component flowing through the re-deposited area that does not contribute to the output of the sensing current becomes larger as the sensor height becomes smaller. On the other hand, it is found that the output from the magnetic reading head of the present embodiment is approximately constant irrespective of the sensor height.

It is expected that the sensor height becomes smaller and smaller from now on with the aim of improvement in recording density in the magnetic read/write apparatus. This is because a magnetic reading head that retains a necessary output even if the track width and the inter-shield distance are made small with the aim of improving MR ratio and recording density by arranging the magneto-resistance film 3 only in the vicinity of the air bearing surface 13 that is most magnetically sensitive is to be realized. When re-deposited layer is present on the side wall surface of the magneto-resistance film 3 in the track width direction as shown in FIG. 7, the current that does not contribute to magnetic resistance change becomes larger as the sensor height is made smaller for the above aim, and thus the output as a sensor becomes smaller. From the result shown in FIG. 19, the magnetic reading head according to the present embodiment proves to be the one in which the loss of the sensing current is small and a high output is realized even when the sensor height is made small.

It should be noted that the foregoing was explained using a tunneling magneto-resistance film comprising the pinned layer composed of a layer containing a ferromagnetic material of cobalt-iron alloy, a insulating layer composed of Al—O or the like, and the free layer composed of a layer containing nickel-iron alloy, cobalt-iron alloy, or the like for the magneto-resistance film 3. However, this is merely one example and the magneto-resistance film is not limited to this. A giant magneto-resistance layer comprising the pinned layer composed of a layer containing a ferromagnetic material of cobalt-iron alloy, the intermediate layer composed of Cu or the like, and the free layer composed of a layer containing nickel-iron alloy, cobalt-iron alloy, or the like may be used. Alternatively, for example, a magneto-resistance film in which a high polarizability material is used for the pinned layer or the free layer, a magneto-resistance film in which a current screen layer is provided to the pinned layer, the intermediate layer, or the free layer, further a magneto-resistance film with magnetic semiconductor, a magneto-resistance film utilizing diffusion and accumulation phenomena of polarized spin, or the like can also be used. As long as the device allows sensing current to flow in the direction approximately perpendicular to the film surface of a material constituting the magneto-resistance film, the effect of the present invention remains unchanged.

Further, the magnetic reading head in which the magneto-resistance film 3 was arranged so as to be exposed at the air bearing surface 13 was mentioned above. However, a similar effect can also be obtained by a magnetic reading head in which only part of the magneto-resistance film 3 is arranged so as to be exposed at the air bearing surface 13 as shown in FIG. 20 or a magnetic reading head in which the magneto-resistance film 3 is arranged at a place distant from the air bearing surface as shown in FIG. 21.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A magnetic head comprising:
a lower shield layer;
an upper shield layer;
a magneto-resistance film formed between the lower shield layer and the upper shield layer;
a refill film along sensor height direction arranged so as to be in contact with the surface opposite to an air bearing surface of the magneto-resistance film; and
a mechanism to allow electric current to flow in the direction along film thickness of the magneto-resistance film,
wherein the refill film along sensor height direction is a stack film and comprises a first refill film along sensor height direction in contact with the magneto-resistance film, and a second refill film along sensor height direction formed on the first refill film along sensor height direction, and the etching rate of the second refill film along sensor height direction is faster than the etching rate of the first refill film along sensor height direction.

2. The magnetic head according to claim 1, wherein Vickers hardness of the second refill film along sensor height direction is lower than Vickers hardness of the first refill film along sensor height direction.

3. The magnetic head according to claim 1, wherein the vapor pressure of carbonyl compound from the second refill film along sensor height direction is higher than the vapor pressure of carbonyl compound from the first refill film along sensor height direction.

4. The magnetic head according to claim 1, wherein the first refill film along sensor height direction is formed of alumina.

5. The magnetic head according to claim 1, wherein the first refill film along sensor height direction is formed of alumina and the second refill film along sensor height direction comprises nickel oxide, silicon oxide, silicon nitride, tantalum oxide, aluminum nitride, or zirconium oxide.

6. The magnetic head according to claim 1, wherein the first refill film along sensor height direction is formed of alumina and the second refill film along sensor height direction is formed of metal containing at least one of nickel-iron alloy, Rh, Ru, Au, Cr, nickel-chromium alloy, nickel-iron-chromium alloy, Cu, and Ta.

7. The magnetic head according to claim 1, wherein all layers constituting the refill film along sensor height direction are formed of insulating materials.

8. The magnetic head according to claim 1, wherein the first refill film along sensor height direction comprises an insulating material and the second refill film along sensor height direction comprises a metal.

9. The magnetic head according to claim 1, wherein the magneto-resistance film is a giant magneto-resistance layer provided with a free layer, an intermediate layer, and a pinned layer.

10. The magnetic head according to claim 1, wherein the magneto-resistance film is a tunneling magneto-resistance film provided with the free layer, an insulating layer, and the pinned layer.

11. A magnetic head comprising:
a lower shield layer;
an upper shield layer;
a magneto-resistance film formed between the lower shield layer and the upper shield layer;
a refill film along track width direction arranged so as to be in contact with the side surface of the magneto-resistance film in the track width direction; and
a mechanism to allow electric current to flow in the direction along film thickness of the magneto-resistance film,
wherein the refill film along track width direction is a stack film and comprises a first refill film along track width direction and a second refill film along track width direction formed on the first refill film along track width direction, and the etching rate of the second refill film along track width direction is faster than the etching rate of the first refill film along track width direction.

12. The magnetic head according to claim 11, wherein Vickers hardness of the second refill film along track width direction is lower than Vickers hardness of the first refill film along track width direction.

13. The magnetic head according to claim 11, wherein the vapor pressure of carbonyl compound from the second refill film along track width direction is higher than the vapor pressure of carbonyl compound from the first refill film along track width direction.

14. The magnetic head according to claim 11, wherein the first refill film along track width direction is formed of alumina.

15. The magnetic head according to claim 11, wherein the first refill film along track width direction is formed of alumina and the second refill film along track width direction comprises nickel oxide, silicon oxide, silicon nitride, tantalum oxide, aluminum nitride, or zirconium oxide.

16. The magnetic head according to claim 11, wherein the first refill film along track width direction is formed of alumina and the second refill film along track width direction is formed of a metal containing at least one of nickel-iron alloy, Rh, Ru, Au, Cr, nickel-chromium alloy, nickel-iron-chromium alloy, Cu, and Ta.

17. The magnetic head according to claim 11, wherein all layers constituting the refill film along a track width direction are formed of insulating materials.

18. The magnetic head according to claim 11, wherein the first refill film along a track width direction comprises an insulating material and the second refill film along a track width direction comprises a metal.

19. The magnetic head according to claim 11, wherein the magneto-resistance film is a giant magneto-resistance layer provided with a free layer, an intermediate layer, and a pinned layer.

20. The magnetic head according to claim 11, wherein the magneto-resistance film is a tunneling magneto-resistance film provided with the free layer, an insulating layer, and the pinned layer.

21. A fabrication process of a magnetic head provided with a lower shield layer, an upper shield layer, a magneto-resistance film fabricated between the lower shield layer and the upper shield layer, a refill film along a sensor height direction arranged so as to be in contact with the surface opposite to an air bearing surface of the magneto-resistance film, a refill film along a track width direction arranged so as to be in contact with the side surface of the magneto-resistance film in the track width direction, and a mechanism to allow electric current to flow in the direction along film thickness of the magneto-resistance film, the fabrication process comprising:
forming the magneto-resistance film on the lower shield layer;
forming a first lift-off mask on the magneto-resistance film;
sensor height forming the magneto-resistance film by etching with the use of the first lift-off mask as a mask;
forming a multi-layer refill film along a sensor height direction by fabricating a first refill film along a sensor height direction on the side surface of the magneto-resistance film in the sensor height direction and fabricating thereon a second refill film along a sensor height direction with an etching rate faster than that of the first refill film along a sensor height direction;
lifting off the first lift-off mask;
forming a second lift-off mask on the magneto-resistance film;
track forming the magneto-resistance film by etching with the use of the second lift-off mask as a mask;
forming the refill film along a track width direction on the side surface of the magneto-resistance film in the track width direction; and
lifting off the second lift-off mask.

22. The fabrication process of the magnetic head according to claim 21, wherein
sensor height forming the magneto-resistance film includes first etching by an ion milling method carried out at an ion incidence angle of about 0 to 45 degrees and subsequent second etching by the ion milling method further carried out at an ion incidence angle of about 60 to 80 degrees; and
track forming the magneto-resistance film includes first etching by the ion milling method carried out at an ion incidence angle of about 0 to 45 degrees and subsequent second etching by the ion milling method further carried out at an ion incidence angle of about 60 to 80 degrees.

23. The fabrication process of the magnetic head according to claim 21, wherein the first refill film along a sensor height direction is formed of alumina and the second refill film along a sensor height direction is formed of a material that contains nickel oxide, silicon oxide, silicon nitride, tantalum oxide, aluminum nitride, or zirconium oxide.

24. A fabrication process of a magnetic head provided with a lower shield layer, an upper shield layer, a magneto-resistance film fabricated between the lower shield layer and the upper shield layer, a refill film along a sensor height direction arranged so as to be in contact with the surface opposite to an air bearing surface of the magneto-resistance film, a refill film along a track width direction arranged so as to be in contact with the side surface of the magneto-resistance film in the track width direction, and a mechanisms to allow electric current to flow in the direction along film thickness of the magneto-resistance film, the fabrication process comprising:
forming the magneto-resistance film on the lower shield layer;
forming a first lift-off mask on the magneto-resistance film;
track forming the magneto-resistance film by etching with the use of the first lift-off mask as a mask;
forming a multi-layer refill film along a track width direction by fabricating a first refill film along a track width direction on the side surface of the magneto-resistance film in the track width direction and fabricating thereon a second refill film along a track width direction with an etching rate faster than that of the first refill film along a track width direction;
lifting off the first lift-off mask;
forming a second lift-off mask on the magneto-resistance film;
sensor height forming the magneto-resistance film by etching with the use of the second lift-off mask as a mask;
forming the refill film along a sensor height direction on the side surface of the magneto-resistance film in the sensor height direction; and
lifting off the second lift-off mask.

25. The fabrication process of the magnetic head according to claim 24, wherein
track forming the magneto-resistance film includes first etching by an ion milling method carried out at an ion incidence angle of about 0 to 45 degrees and subsequent second etching by the ion milling method further carried out at an ion incidence angle of about 60 to 80 degrees; and
sensor height forming the magneto-resistance film includes first etching by the ion milling method carried out at an ion incidence angle of about 0 to 45 degrees and subsequent second etching by the ion milling method further carried out at an ion incidence angle of about 60 to 80 degrees.

26. The fabrication process of the magnetic head according to claim 24, wherein the first refill film along a track width direction is formed of alumina and the second refill film along a track width direction is formed of a material that contains nickel oxide, silicon oxide, silicon nitride, tantalum oxide, aluminum nitride, or zirconium oxide.

27. A magnetic read/write apparatus including a magnetic head mounting magnetic recording media, a motor to drive the magnetic recording media, a writing head, and a reading head; an actuator to drive the magnetic head relative to the magnetic recording media; and a signal processing module to process writing signals sent to the writing head and reading signals from the reading head, wherein
the reading head includes a lower shield layer, an upper shield layer, a magneto-resistance film formed between the lower shield layer and the upper shield layer, a refill film along a sensor height direction arranged so as to be in contact with the surface opposite to an air bearing surface of the magneto-resistance film, and a mechanism to allow electric current to flow in the direction along film thickness of the magneto-resistance film; the refill film along a sensor height direction is a stack film and comprises a first refill film along a sensor height direction in contact with the magneto-resistance film and a second refill film along a sensor height direction formed on the first refill film along a sensor height direction; and the etching rate of the second refill film along a sensor height direction is faster than the etching rate of the first refill film along a sensor height direction.

28. A magnetic read/write apparatus including a magnetic head mounting magnetic recording medium, a motor to drive the magnetic recording media, a writing head, and a reading head; an actuator to drive the magnetic head relative to the magnetic recording medium; and a signal processing module to process writing signals sent to the writing head and reading signals from the reading head, wherein
the reading head includes a lower shield layer, an upper shield layer, a magneto-resistance film formed between the lower shield layer and the upper shield layer, a refill film along a track width direction arranged so as to be in contact with the side surface of the magneto-resistance film in the track width direction, and a mechanism to allow electric current to flow in the direction along film thickness of the magneto-resistance film; the refill film along a track width direction is a stack film and comprises a first refill film along track width direction in contact with the magneto-resistance film and a second refill film along track width direction formed on the first refill film along track width direction, and the etching rate of the second refill film along track width direction is faster than the etching rate of the first refill film along track width direction.
